(19) United States
(12) Patent Application Publication
(10) Pub. No.: US 2024/0095527 A1
(43) Pub. Date: Mar. 21, 2024

(54) TRAINING MACHINE LEARNING MODELS USING SIMULATION FOR ROBOTICS SYSTEMS AND APPLICATIONS

(71) Applicant: NVIDIA CORPORATION, Santa Clara, CA (US)

(72) Inventors: Ankur HANDA, San Jose, CA (US); Gavriel STATE, Toronto (CA); Arthur David ALLSHIRE, Toronto (CA); Dieter FOX, Seattle, WA (US); Jean-Francois Victor LAFLECHE, Toronto (CA); Jingzhou LIU, Oakville (CA); Viktor MAKOVIICHUK, Santa Clara, CA (US); Yashraj Shyam NARANG, Seattle, WA (US); Aleksei Vladimirovich PETRENKO, Cupertino, CA (US); Ritvik SINGH, Toronto (CA); Balakumar SUNDARALINGAM, Seattle, WA (US); Karl VAN WYK, Issaquah, WA (US); Alexander ZHURKEVICH, San Jose, CA (US)

(21) Appl. No.: 18/448,049

(22) Filed: Aug. 10, 2023

Related U.S. Application Data
(60) Provisional application No. 63/407,560, filed on Sep. 16, 2022.

(51) Int. Cl. G06N 3/08

(52) U.S. Cl. CPC G06N 3/08

(57) ABSTRACT

Systems and techniques are described related to training one or more machine learning models for use in control of a robot. In at least one embodiment, one or more machine learning models are trained based at least on simulations of the robot and renderings of such simulations—which may be performed using one or more ray tracing algorithms, operations, or techniques.

### CLAIM OF PRIORITY

This application claims the benefit of U.S. Provisional Application No. 63/407,560 (Attorney Docket No. 22-RE-1289US01) titled “Transfer of Agile In-hand Manipulation from Simulation to Reality,” filed Sep. 16, 2022, the entire contents of which is incorporated herein by reference.

### TECHNICAL FIELD

Embodiments of the present disclosure relate generally to computer science and robotics and, more specifically, to techniques for using simulations to train machine learning models for use in robotics operations.

### BACKGROUND

Robots are being increasingly used to perform tasks automatically or autonomously in various environments. One approach for controlling a robot to perform a task is to first train a machine learning model that is then used to control the robot to perform the task. The machine learning model can be trained using training data that is generated via simulation or otherwise.

One drawback of using conventional simulation techniques to generate training data is that, as a general matter, the training data generated by these techniques is not sufficiently realistic. When a machine learning model that has been trained on insufficiently realistic training data is deployed to control a physical robot in a real-world environment, the machine learning model can fail to correctly control the robot to perform a task.

To address the above deficiencies, some conventional techniques use training data generated using a physical robot that is programmed to perform tasks in a real-world environment. These types of approaches are sometimes referred to as “real-world” training. One drawback of real-world training is that this type of training can cause damage, including wear and tear, to the robot that performs tasks in the real-world environment and to objects with which the robot interacts.

As the foregoing illustrates, what is needed in the art are more effective techniques for controlling robots to perform tasks.

### BRIEF DESCRIPTION OF DRAWINGS

FIG. 1 illustrates a block diagram of a computer-based system configured to implement one or more aspects of at least one embodiment;

FIG. 2 illustrates in greater detail the computing device of FIG. 1, according to at least one embodiment;

FIG. 3 illustrates how the vision and robot control models of FIG. 1 can be used to control a robot, according to at least one embodiment;

FIG. 4 illustrates how the vision model of FIG. 1 can be trained, according to at least one embodiment;

FIG. 5 illustrates how the robot control model of FIG. 1 can be trained, according to at least one embodiment;

FIG. 6 illustrates a flow diagram of a process for training a vision model, according to at least one embodiment;

FIG. 7 illustrates a flow diagram of a process for training a robot control model, according to at least one embodiment;

FIG. 8 illustrates a flow diagram of a process for controlling a robot using trained vision and robot control models, according to at least one embodiment;

FIG. 9A illustrates inference and/or training logic, according to at least one embodiment;

FIG. 9B illustrates inference and/or training logic, according to at least one embodiment; and

FIG. 10 illustrates training and deployment of a neural network, according to at least one embodiment.

### DETAILED DESCRIPTION

Embodiments of the present disclosure provide improved techniques for training and using machine learning models in robotics systems and applications. In at least one embodiment, the machine learning models include a vision model that is trained to process images of a robot, which may interact with one or more objects, and a robot control model that is trained to generate robot actions based on a goal, an output of the vision model, and/or previous states of the robot. In at least one embodiment, the vision model is trained using (1) images of simulations of the robot that are rendered via ray tracing with different camera parameters and/or visual effects, and (2) augmentations of the rendered images. In at least one embodiment, the robot control model is trained using reinforcement learning and simulations of the robot in which physics and/or non-physics parameters of the simulations are randomized. In such cases, an automatic domain randomization (ADR) technique can be used to randomize the physics and/or non-physics parameters. Once trained, the vision model and the robot control model can be deployed to aid in the control of a robot to perform tasks in a real-world environment.

The techniques for training and using machine learning model(s) to control robots to perform tasks have many real-world applications. For example, those techniques could be used to control a robot to grasp and manipulate an object. As a further example, those techniques could be used to control a robot to place an object into a package. As yet another example, those techniques could be used to control a robot to move (e.g., to walk) within an environment.

The above examples are not in any way intended to be limiting. As persons skilled in the art will appreciate, as a general matter, the techniques for controlling robots described herein can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs) that may process text, audio, and/or image data, systems for performing light transport simulation, systems for performing collaborative content creation for 3D assets, systems implemented at least partially using cloud computing resources, and/or other types of systems.

### System Overview

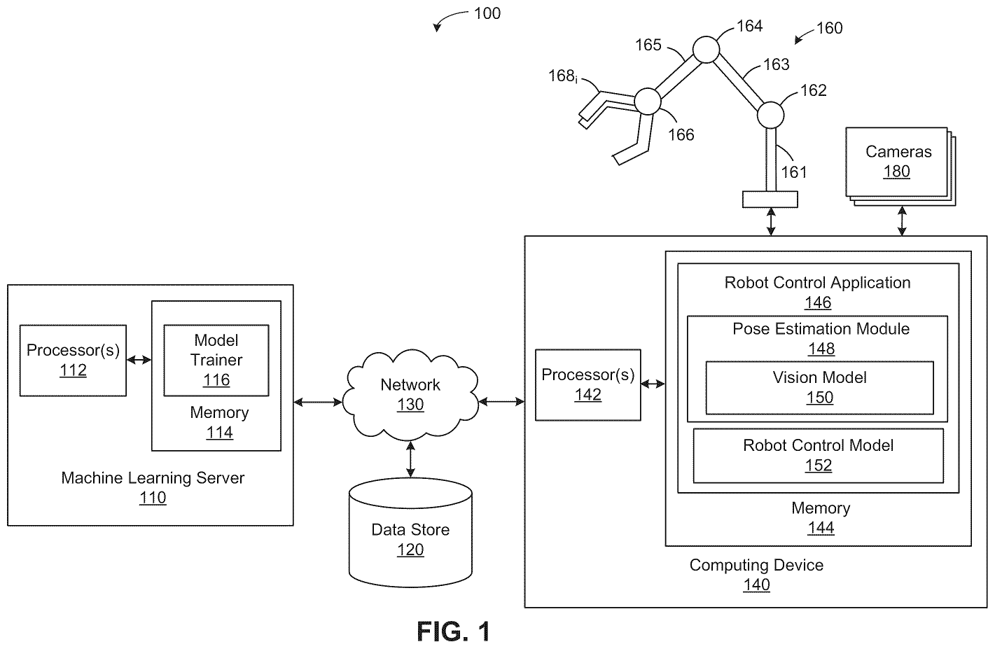

FIG. 1 illustrates a block diagram of a computer-based system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In at least one embodiment, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In at least one embodiment, any combination of the processor(s) 112, the system memory 114, and/or GPU(s) can be included in and/or replaced with any type of virtual computing system, distributed computing system, and/or cloud computing environment, such as a public, private, or a hybrid cloud system.

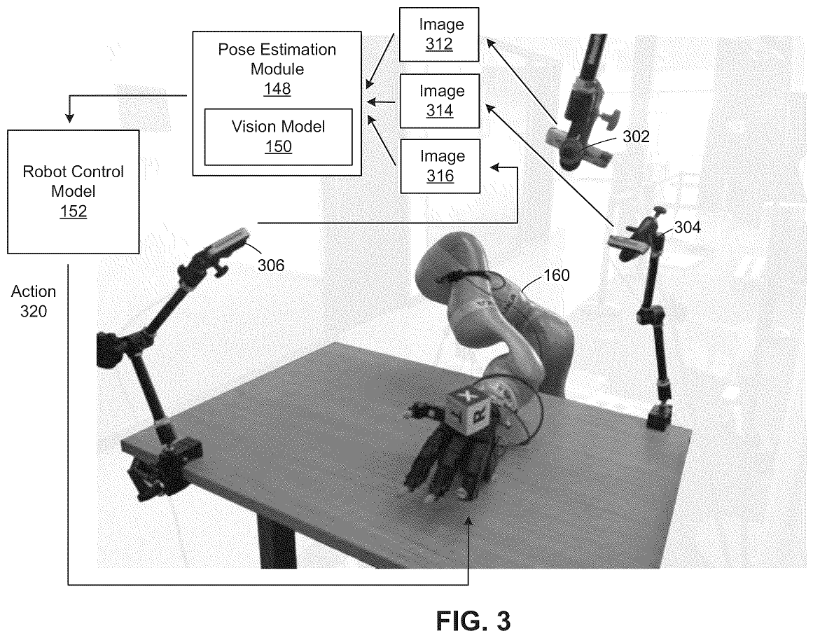

In at least one embodiment, the model trainer 116 is configured to train one or more machine learning models, including a vision model 150 and a robot control model 152, or instances or versions thereof. In such cases, the vision model 150 is trained to process images of a robot, which may interact with one or more objects, to generate an output. The robot control model 152 is trained to generate actions for a robot to perform based on a goal, an output of the vision model 150, and previous states of the robot (e.g., previous joint angles). Architectures of the vision model 150 and the robot control model 152, as well as techniques for training the same, are discussed in greater detail herein in conjunction with at least FIGS. 3-7. Training data and/or trained (or deployed) machine learning models, including the vision model 150 and the robot control model 152, can be stored in the data store 120. In at least one embodiment, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

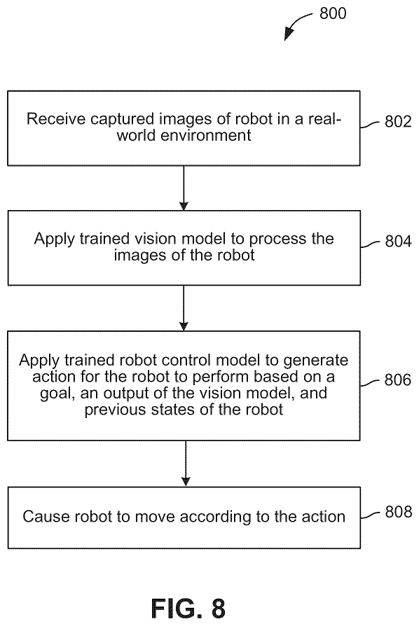

As shown, a robot control application 146 that uses the vision model 150 and the robot control model 152 is stored in a system memory 144, and executes on a processor 142, of the computing device 140. Once trained, the vision model 150 and the robot control model 152 can be deployed, such as via robot control application 146. Illustratively, given images captured by cameras, such as cameras 180, the trained vision model 150 and robot control model 152 can be used by a pose estimation module 148 to estimate the pose(s) of object(s) with which a robot (e.g., robot 160) interacts, and to control the robot to perform tasks, respectively, as discussed in greater detail herein in conjunction with at least FIG. 8.

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168i (referred to herein collectively as fingers 168 and individually as a finger 168) that can be controlled to grip an object. For example, in at least one embodiment, the robot 160 may include a locked wrist and multiple (e.g., four) fingers. Although an example robot 160 is shown for illustrative purposes, in at least one embodiment, techniques disclosed herein can be applied to control any suitable robot.

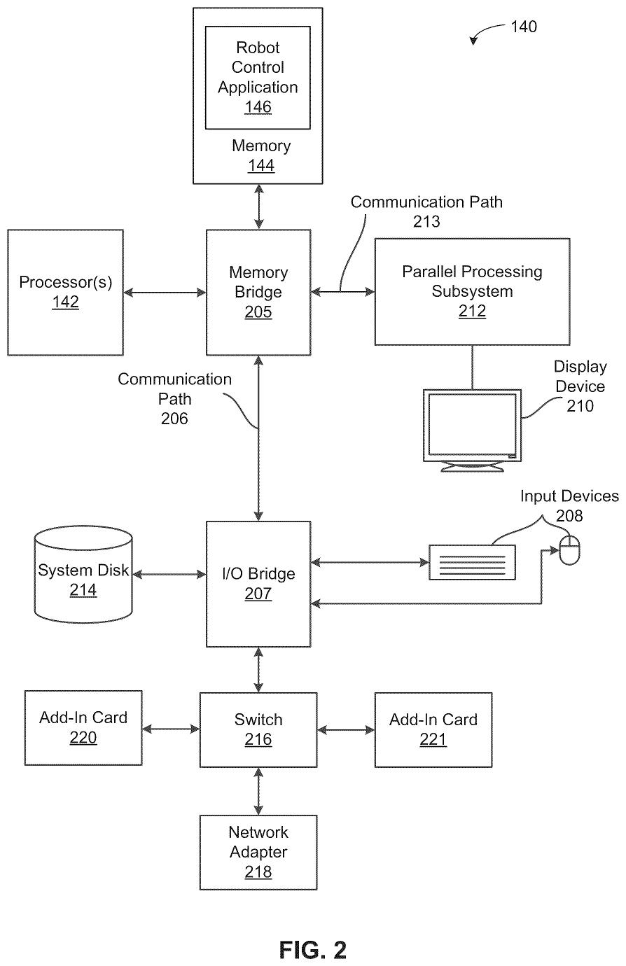

FIG. 2 is a block diagram illustrating the computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, computing device 140 is a server machine operating in a data center or a cloud computing environment that provides scalable computing resources as a service over a network. In at least one embodiment, the machine learning server 110 can include one or more similar components as the computing device 140.

In various embodiments, the computing device 140 includes, without limitation, the processor(s) 142 and the memory(ies) 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In at least one embodiment, the computing device 140 may be a server machine in a cloud computing environment. In such embodiments, computing device 140 may not include input devices 208, but may receive equivalent input information by receiving commands (e.g., responsive to one or more inputs from a remote computing device) in the form of messages transmitted over a network and received via the network adapter 218. In at least one embodiment, switch 216 is configured to provide connections between I/O bridge 207 and other components of the computing device 140, such as a network adapter 218 and various add-in cards 220 and 221.

In at least one embodiment, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In at least one embodiment, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In at least one embodiment, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 144 includes at least one device driver configured to manage the processing operations of the one or more PPUs within parallel processing subsystem 212. In addition, the system memory 144 includes the robot control application 146. The robot control application 146 can be any technically feasible application that controls a robot (e.g., the robot 160) using techniques disclosed herein. For example, in some embodiments, the robot control application 146 can control a robot to grasp and manipulate an object, to place an object into a package, and/or to move (e.g., to walk) within an environment. Although described herein primarily with respect to the robot control application 146, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In at least one embodiment, processor(s) 142 includes the primary processor of computing device 140, controlling and coordinating operations of other system components. In at least one embodiment, the processor(s) 142 issues commands that control the operation of PPUs. In at least one embodiment, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in at least one embodiment, system memory 144 could be connected to the processor(s) 142 directly rather than through memory bridge 205, and other devices may communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

Transfer of Robot Control from Simulation to Reality

FIG. 3 illustrates how the vision model 150 and the robot control model 152 of FIG. 1 can be used to control the robot 160, according to at least one embodiment. As shown, the pose estimation module 148 uses the vision model 150 to process images 312, 314, and 316 of the robot 160 that are captured using RGB cameras 302, 304, and 306, respectively, in order to estimate pose(s) of object(s) in the images 312, 314, and 316. The pose(s) estimated by the pose estimation module 148 are then input into the robot control model 152, which generates an action 320 to be performed by the robot 160. In at least one embodiment, the robot 160 may interact with one or more objects in the images 312, 314, and 316. For example, in at least one embodiment, the robot 160 may manipulate an object, such as a cube with stickers on the sides to distinguish between different faces or any other suitable object, and the object is also captured in the images 312, 314, and 316. In at least one embodiment, the cameras 302, 304, and 306 are extrinsically calibrated relative to a link of the robot 160. Returning to the example of a robot that manipulates an object, cameras may be calibrated relative to a palm link of a hand of the robot, and a pose of the object can be represented with respect to the palm link of the robot hand. As a result of the camera-camera extrinsics and the camera-robot calibration, a pose of the object can be transformed from a canonical reference frame of a camera that captures an image to a reference frame of the link of the robot, such as the palm link of the robot. As the object is represented locally in the reference frame of the link of the robot, the setup of the cameras does not affect operation of the robot control model 152. In particular, the setup of the virtual cameras in simulations performed during training of the robot control model 152 can be different from the setup of physical cameras in a real-world environment that the trained robot control model 152 is deployed to control a physical robot in.

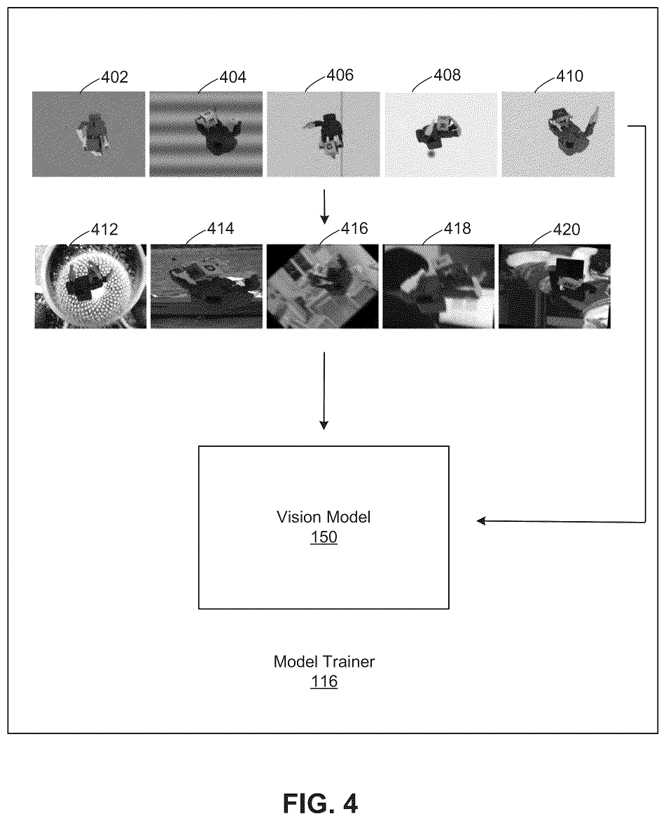

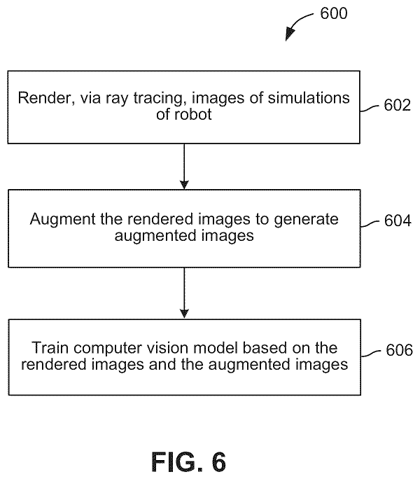

In at least one embodiment, the vision model 150 is an artificial neural network that has a Mask-RCNN (region-based convolutional neural network) or similar architecture, and that takes as input a captured image (e.g., one of the images 312) and outputs bounding shape(s) (e.g., box, rectangle, square, triangle, etc.), segmentation(s), and/or keypoints associated with object(s) that the robot interacts with in the image. In such cases, the segmentation(s) and bounding shape(s) can be useful to segment navigable regions or find out locations of particular object(s), especially in indoor settings where keypoints can also be useful for pose estimation. Generating the bounding shape(s) can help the vision model 150 to localize the object(s) the robot interacts with, and thereby output more accurate segmentation(s) and keypoints associated with the object(s). Returning to the example of a robot that manipulates a cube, a bounding shape may bound the cube, a segmentation may indicate pixels in the image belonging to the cube and not to the cube, and keypoints may indicate corners of the cube. In at least one embodiment, the vision model 150 can be trained using (1) images of simulations of the robot that are rendered via ray tracing with different random camera parameters and visual effects, and/or (2) random augmentations of the rendered images, as discussed in greater detail herein in conjunction with at least FIGS. 4 and 6. Given (1) keypoints associated with object(s) the robot interacts with in multiple captured images that are output by the vision model 150 after the multiple images are processed by the vision model 150, and (2) known camera positions relative to each other, the pose estimation module 148 can perform triangulation to determine 3D positions of the keypoints, and then register the 3D positions of the keypoints against model(s) of the object(s) the robot interacts with to obtain pose(s) (including the position and orientation) of the object(s) in a canonical reference frame. Although described herein primarily with respect to estimating the pose(s) of object(s) that a robot interacts with, in at least one embodiment in which a robot does not interact with objects, such as when the robot is controlled to move (e.g., to walk) within an environment, the pose estimation module 148 can estimate the pose of the robot, itself, in any technically feasible manner. For example, in at least one embodiment, the pose estimation module 148 can directly read the joint angles of the robot, representing the pose of the robot, from an application programming interface (API) that deals with hardware of the robot.

The robot control model 152 generates an action 320 to be performed by the robot 160 based on a goal to be reached, the pose(s) estimated by the pose estimation module 148, and/or previous states of the robot 160. Robot control models, such as the robot control model 152, are also sometimes referred to as policy models. In at least one embodiment, the robot 160 can be controlled to perform any technically feasible task. The goal that is input into the robot control model 152 will generally depend on the task to be performed by the robot 160. Returning to the example of a robot that manipulates an object such as a cube, the task may be object reorientation in an anthropomorphic hand of the robot, and the goal may be target orientation of the object. In such a case, the object can initially be placed on a palm of the robot hand, and a random target orientation of the object can be sampled in SO(3). Then, the robot control model 152 orchestrates motion of fingers of the robot hand so as to bring the object to a desired target orientation. If the object orientation is within a specified threshold of a certain number of radians of the target orientation, a new target orientation can be sampled, and the fingers of the robot hand can continue from the current configuration and aim to move the object to the new target orientation.

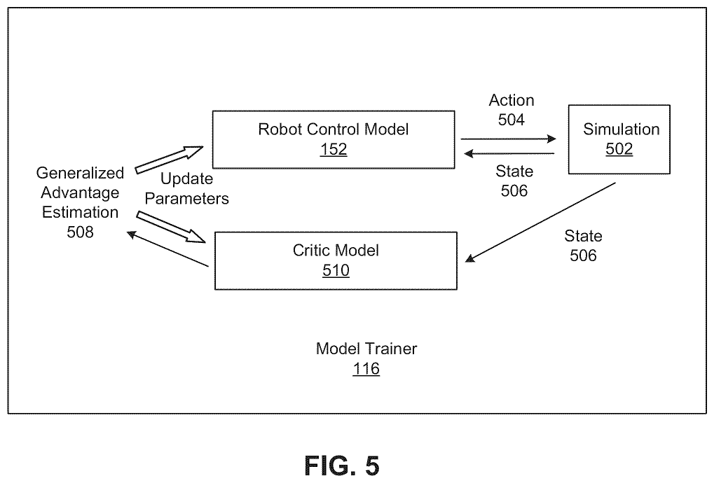

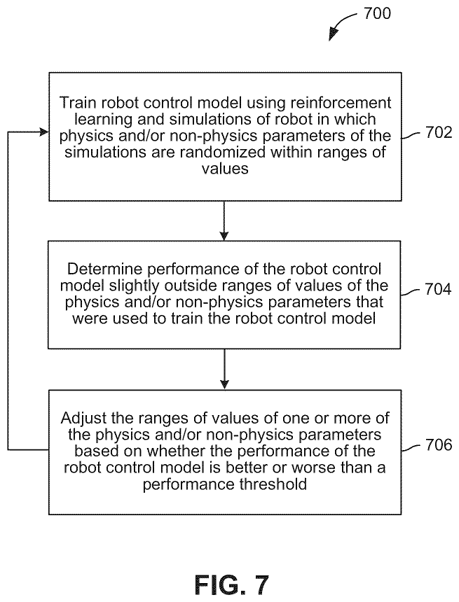

In at least one embodiment, the action 320 generated by the robot control model 152 can be in the form of input to a controller of the robot 160 that causes the robot 160 to move. For example, the action 320 may include joint angles to be reached by joints of the robot 160. The robot control application 146 can send the action 320 output by the robot control model 150 to the controller of the robot 160, thereby causing the robot 160 to perform the action. In at least one embodiment, the robot control model 152 is trained using reinforcement learning and simulations of the robot 160 in which physics and/or non-physics parameters of the simulations are randomized. However, in some embodiments, one or more of the parameters may not be randomized. In addition, an ADR technique can be used to randomize the physics and/or non-physics parameters, as discussed in greater detail herein in conjunction with at least FIGS. 5 and 7. The randomizations described herein are used to generate diverse training data for training the vision model 150 and the robot control model 152. As a result, the trained vision model 150 and robot control model 152 can be used to control a robot to perform tasks successfully in real-world environments.

More formally, a task to be performed by a robot can be modeled as a sequential decision making problem where the robot control model 152 interacts with the environment in order to maximize the sum of discounted rewards. In at least one embodiment, the decision making problem can be formulated as a discrete-time, partially observable Markov Decision Process (POMDP). In such cases, a proximal policy optimization (PPO) technique can be used to learn the robot control model 152 as a parametric stochastic policy π_{θ} (actor) that maps observations o∈ [symbol] in the form of captured images to actions a ∈ [symbol] . PPO additionally learns a function V_{ϕ}^{π}(s) (critic) that approximates the on-policy value function. In at least one embodiment, the critic does not take as input the same observations as the robot control model 152. Instead, the critic takes as input additional observations including states s ∈ [symbol] in the POMDP, which are also referred to herein as “privileged information.” It should be understood that the robot control model 152 will not have access to privileged information when being deployed to control a real-world robot, but the privileged information may allow the critic to make more accurate value estimates of whether the policy is performing well during training.

FIG. 4 illustrates how the vision model 150 of FIG. 1 can be trained, according to at least one embodiment. In at least one embodiment, the model trainer 116 (or another application) performs a ray tracing technique to render a set of images of a robot, which may be interacting with one or more objects in the rendered images. For example, NVIDIA RTX® ray tracing may be used to render the images in at least one embodiment. Examples of images 402, 404, 406, 408, and 410 that were rendered via ray tracing are shown. In at least one embodiment, the images may be rendered from the perspectives of multiple virtual cameras. In at least one embodiment, the images may be rendered with different camera parameters and/or visual effects, so that a vision model (e.g., vision model 150) trained using such images is robust to the different camera parameters and visual effects.

In at least one embodiment, the model trainer 116 further augments the set of rendered images to generate a set of augmented images. Examples of images 412, 414, 416, 418, and 420 that have been augmented are shown. In at least one embodiment, any technically feasible augmentation(s) may be applied with any suitable probability. In at least one embodiment, the augmentations may include lighting, texture, and/or geometry augmentations to the rendered images. In at least one embodiment, the augmentations may be applied with a fixed probability to ensure that a batch of images includes a combination of original images as well as augmented images. Examples of augmentations that may be applied in at least one embodiment include blurring by a random amount, adding a random background, applying a random rotation, applying a random brightness and contrast, applying a random cropping and/or resizing, and/or applying a CutMix in which an image region is removed and replaced with a patch from another image.

As described, visual domain augmentations during rendering permits a trained vision model to be robust to different camera parameters and visual effects that may be present in a real-world scene. The additional data augmentations that are applied to rendered images add even more variety to the training set, and prevent the model from overtraining to any particular type of data and/or features represented thereby. As a result, a single rendered image from a dataset can provide multiple training examples with different data augmentation settings, which can save both rendering time and storage space. For example, because motion blur can be time consuming to generate at rendering time, the model trainer 116 can instead generate motion blur on the fly by smearing a rendered image with a Gaussian kernel, with the blur direction and extent being chosen randomly. In addition, in at least one embodiment, configurations of the robot and/or object(s) generated by the robot control model 152 running in real-world environments can be collected and played back in a physics simulator to render data where pose estimates of the robot and/or object(s) are not fully reliable, such as when pose estimates are not accurate all of the time. The pose estimates can be unreliable due to the simulation-to-reality gap resulting from either sparse sampling or insufficient lighting randomizations for particular configurations. Playback of the collected configurations in simulation enables dense sampling of pose and lighting around such configurations with more randomizations. As a result, a larger dataset can be generated to improve the reliability of pose estimation in the real world, e.g., close the perception loop between reality and simulation by mining configurations from the current best policy model in the real world and using such configurations in simulation to render more images.

Thereafter, the model trainer 116 trains the vision model 150 using the set of rendered images and the set of augmented images. As described, in at least one embodiment, the vision model 150 is a Mask-RCNN that takes as input a captured image and outputs bounding shape(s), segmentation(s), and keypoints associated with object(s) the robot interacts with in the captured image. In such cases, each bounding shape can localize an object the robot interacts with in the image, and each keypoint head can regress to positions associated with the object within the bounding shape (e.g., the eight corners of a cube when the cube is the object). In addition, the vision model 150 can be trained with a cross-entropy loss for segmentation and keypoint location regression, and a smooth L1 loss for bounding shape regression. In at least one embodiment, the adaptive moment optimization (ADAM) optimizer with a learning rate of 1e-4 can be used during training of the vision model 150. In at least one embodiment, in order to make pose estimates reliable for the downstream robot control model 150, a perspective n point (PnP) technique can be performed on each camera to determine projected keypoints, and cameras whose projected keypoints from the PnP technique do not match the inferred keypoints from the vision model 150 are filtered out. Keypoints from the filtered out cameras can then be triangulated and registered against model(s) of the object(s) the robot interacts with to obtain pose(s) of the object(s) in a canonical reference frame.

FIG. 5 illustrates how the robot control model 152 of FIG. 1 can be trained, according to at least one embodiment. In at least one embodiment, the vision model 150 and the robot control model 152 can be trained separately, and then stitched together when being deployed. As shown, in at least one embodiment, the model trainer 116 trains the robot control model 152 using reinforcement learning and simulations of a robot in which physics and/or non-physics parameters of the simulations are randomized within ranges of values. The randomizations are introduced into the simulation environment to help overcome the “sim-to-real” gap between physics simulators and real-world environments. As described, a robot control model cannot be properly trained on training data that is generated using conventional simulation techniques, because such training data is oftentimes not sufficiently realistic. In addition, a physical robot system can change from day to day—for example, due to wear-and-tear—and even from time-step to time-step—for example, due to stochastic noise.

During individual simulations, a sequence of actions may be chained together to form a trajectory. Beginning with random trajectories in different simulations, the reinforcement learning trains the robot control model 152 to learn to generate actions that can be used to achieve a goal by updating parameters of the robot control model 152 based on whether the trajectories lead to states of the robot and/or object(s) with which the robot interacts that are closer or further from the goal, as discussed in greater detail below. Although one simulation 502 is shown for illustrative purposes, in at least one embodiment, multiple simulations may be performed in parallel on one or more GPUs. For example, in at least one embodiment, a GPU-based physics simulator may be used to execute multiple simulations in parallel. In at least one embodiment, the physics parameters that are randomized during the simulations may include gravity, mass, scale, friction, armature, effort, joint stiffness, joint damping, and/or restitution associated with the robot and/or one or more objects that the robot interacts with. In at least one embodiment, the non-physics parameters that are randomized during the simulations may include a robot and/or object pose delay probability, a robot and/or object pose frequency, an observed correlated noise, an observed uncorrelated noise, a random pose injection for a robot and/or object, an action delay probability, an action latency, an action correlated noise, an action uncorrelated noise, and/or a random network adversary (RNA) α. Physics randomizations can be applied to account for both changing real-world dynamics and the inevitable gaps between physics in simulation and reality. As described, in at least one embodiment, the physics parameters that are randomized can include basic properties such as mass, friction, and restitution of component(s) (e.g., a hand) of a robot and/or object(s) that the robot interacts with. In such cases, the component(s) of the robot and the object(s) can also be randomly scaled to avoid over-reliance on exact morphologies. In addition, joint stiffness, damping, and limits, as well as forces on a robot and/or object(s) the robot interacts with can be randomized. In addition to physics randomizations, non-physics randomizations, such as action and observation randomizations, can be useful for achieving desirable real-world performance when the trained robot control model 152 is deployed. Examples of action parameters that may be randomized during simulations include the action delay probability, action latency, action correlated noise, action uncorrelated noise, and/or RNDA α, described above. Examples of observation parameters that may be randomized during simulations include the robot and/or object pose delay probability, a robot and/or object pose frequency, observed correlated noise, observed uncorrelated noise, and random pose injection for a robot and/or object, described above.

To make the robot control model 152 more robust to the changing inference frequency and jitter resulting from a robot operating system (ROS)-based inference system, stochastic delay can be added to the pose(s) of object(s) that the robot interacts with as well the action delivery time and fixed-for-an-episode action latency. To account for unmodeled dynamics, an RNA technique can be performed, in which a randomly generated neural network is used to introduce structured noise patterns into the simulation environment in each episode. In at least one embodiment, when simulations are performed on GPU(s) rather than CPU(s), a single randomly generated neural network can be generated and used across all environments, and a unique and periodically refreshed dropout pattern can be used per environment, rather than using a new neural network per environment-episode. In such cases, actions from the RNA neural network can be blended with actions from the robot control model 152 by a=α ·aRNA+(1−α)·a_{policy}, where α is controlled by the ADR technique.

During each iteration of the reinforcement learning, the model trainer 116 updates parameters of the robot control model 152 and a critic model 510 that is trained along with the robot control model 152. As described, the critic model 510 approximates an estimated value function that is used to criticize actions generated by the robot control model 152. Illustratively, after the robot control model 152 generates an action 504 that is performed by a robot in the simulation 502, the critic model 510 computes a generalized advantage estimation 508 based on (1) a new state 506 of the robot and/or object(s) that the robot interacts with, and (2) a reward function. The generalized advantage estimation 508 indicates whether the new state 506 is better or worse than expected, and the model trainer 116 updates the parameters of the robot control model 152 such that the robot control model 152 is more or less likely to generate the action 504 based on whether the new state 506 is better or worse, respectively.

In at least one embodiment, any technically feasible reward function can be used in computing the generalized advantage estimation 508, and the reward function that is used will generally depend on the robot and the task to be performed by the robot. In at least one embodiment, the reward function may include one or more terms that penalize robot motions that are not smooth (e.g., robot motions with large changes in acceleration) and/or one or more terms that penalize violations of real-world constraints (e.g., interpenetrations between the robot and one or more objects). Returning to the example of a robot that manipulates an object using a hand, the reward function that is computed at each time step of the reinforcement learning may include a weighted sum of the following terms: (1) a rotation being close to a goal, 1/(d+0.1), that is weighted by 1.0, where d represents the rotational distance from an orientation of an object to a target orientation; (2) a position being close to a fixed target, ∥p_{object}−p_{goal}, that is weighted by −10.0, where p_{object} and p_{goal} are the position of the object and of a goal, respectively; (3) an action penalty, ∥a∥², that is weighted by −0.001, where a is the current action; (4) an action delta penalty, ∥targ_{curr}−targₚᵣₑᵥ∥², that is weighted by −0.25, where targ_{curr} and targₚᵣₑᵥ are the current and previous joint position targets; (5) a joint velocity penalty ∥vⱼₒᵢₙₜₛ∥², that is weighted by −0.003, where vⱼₒᵢₙₜₛ is the current joint velocity vector; and (6) a reached goal bonus, d<0.1, that is weighted by 250.0.

In at least one embodiment, the critic model 510 may have access to privileged information, such as the physics and/or non-physics parameters that were used during the simulations, that the robot control model 152 does not have access to. As described, the robot control model 152 will not have access to such privileged information when being deployed to control a real-world robot, but the privileged information may allow the critic model 510 to make more accurate value estimates during training. Returning to the example of a robot that manipulates an object using a hand, the robot control model 152 may have access to the following information: object position, object orientation, target position, target orientation, relative target orientation, last actions, and/or robot hand joints angles. In such cases, in addition to the information that the robot control model 152 has access to, the critic model 510 may have access to the following privileged information: stochastic delays, fingertip positions, fingertip rotations, fingertip velocities, fingertip forces and torques, hand joints velocities, hand joints generalized forces, object scale, object mass, object friction, object linear velocity, object angular velocity, object position with noise, object rotation with noise, random forces on object, domain randomization parameters, gravity vector, rotation distances, and/or hand scale.

In at least one embodiment, an ADR technique is used to automatically determine ranges within which the physics and/or non-physics parameters are randomized. In such cases, the ADR can include training the robot control model 152 using certain ranges of the physics and/or non-physics parameters, testing performance of the robot control model 152 slightly outside the ranges, expanding the ranges of the physics and/or non-physics parameters if the performance is below a threshold, shrinking the ranges of the physics and/or non-physics parameters if the performance is above a threshold, and further training the robot control model 152 using the expanded and/or shrunk ranges of physics and/or non-physics parameters if the robot control model 152. In at least one embodiment, a vectorized implementation of ADR can be used. ADR permits policies, such as the robot control model 152, to be trained with enough randomization of behavior exploration early in training while producing final policies that are robust to the largest range of environment conditions possible at the end of training. The range of randomizations for each environment parameter in ADR can be modeled as a uniform distribution ϕ˜U(a, b), where a and b represent the upper and lower bounds of the randomization dimension. During simulation, each simulation environment samples each dimension of their environment parameters from such bounds. Some percentage (e.g., 40%) of the environments are dedicated to evaluation. In such environments, one of the environment dimensions is sampled from the lower or upper boundary, and for each dimension, the number of consecutive successes on that dimension is measured. For example, if the average consecutive successes in the n=256 queue on a particular boundary exceeds the upper threshold t_{H}=20, the range can be widened with a lower bound a←a−Δ. If the performance is below the lower threshold t_{L}=5, then the range can be tightened on that bound. It should be noted that the performance on the upper and lower boundaries on each dimension can be measured separately, and the size of step Δ can also be chosen separately for each dimension. In at least one embodiment, ADR can be run separately on each of multiple GPUs during training of the robot control model 152. Doing so avoids additional synchronization overhead of buffers and partially mitigates the disadvantage of ADR caused by the failure to model the joint distribution, because having multiple independent parameter sets will allow multiple sets of extreme parameters to some extent.

In at least one embodiment, the robot control model 152 is a long short-term memory (LSTM) neural network that provides the policy π_{θ}: [symbol] × [symbol] → [symbol] , and the LSTM neural network takes as input environmental observations o and previous hidden state h∈ [symbol] . For example, in at least one embodiment, an LSTM backpropagation through time (BTT) can be used with truncation length 16, and the LSTM neural network may include a number (e.g., 1024) of hidden units with layer normalization that is followed by 2 multilayer perceptron (MLP) layers with sizes 512 and ELU activation. Returning to the example of a robot that manipulates an object using a hand, the action space [symbol] of the robot control model 152 is the PD controller target for each of the joints of the robot hand. The value function LSTM layer includes a number (e.g., 2048) of hidden units with layer normalization as well, followed by 2 MLP layers that include a number of units and ELU activation. In at least one embodiment, the robot control application 152 also smooths an output of the robot control model 152 using a low-pass filter with an exponential moving average (EMA) smoothing factor. During training, the smoothing factor may be annealed from 0.2 to 0.15. Experience has shown that using an EMA of 0.1 provides a reasonable balance between agility and stability of the robot motion, and further prevents hardware of the robot from breaking or burning motor cables, among other things.

FIG. 6 illustrates a flow diagram of a process 600 for training a vision model, according to at least one embodiment. Although the process is described in conjunction with the systems of FIGS. 1-2, persons skilled in the art will understand that any system configured to perform the process in any order falls within the scope of the present embodiments.

As shown, the process 600 begins at operation 602, where the model trainer 116 renders, via ray tracing, images of simulations of a robot, which may be interacting with one or more objects. In at least one embodiment, the images are rendered with different camera parameters and/or visual effects so that a vision model that is trained using such images is robust to the different camera parameters and visual effects, as described herein in conjunction with FIG. 4. In at least one embodiment, a GPU-based physics simulator is employed to execute multiple simulations, from which images are rendered, in parallel.

At operation 604, the model trainer 116 augments the rendered images to generate augmented images. In at least one embodiment, the augmentations may include lighting, texture, and/or geometry augmentations to the rendered images, as described herein in conjunction with FIG. 4.

At operation 606, the model trainer 116 trains the vision model 150 based on the rendered images and the augmented images. In at least one embodiment, the vision model 150 is a neural network having a Mask-RCNN or similar architecture that is trained to predict bounding shape(s), segmentation(s), and keypoints associated object(s) that the robot interacts with in captured images. In such cases, the vision model 150 can be trained using (1) a cross-entropy loss for segmentation and keypoint location regression and (2) a smooth L1 loss for bounding shape regression, as described herein in conjunction with FIG. 5.

FIG. 7 illustrates a flow diagram of a process 700 for training a robot control model, according to at least one embodiment. Although the process is described in conjunction with the systems of FIGS. 1-2, persons skilled in the art will understand that any system configured to perform the process in any order falls within the scope of the present embodiments.

As shown, the process 700 begins at operation 702, where the model trainer 116 trains the robot control model 152 using reinforcement learning and simulations of a robot in which physics and/or non-physics parameters of the simulations are randomized within ranges of values. Examples of physics and/or non-physics parameters that may be randomized in at least one embodiment are described herein in conjunction with at least FIG. 5.

At operation 704, the model trainer 116 determines performance of the robot control model 152 slightly outside the ranges of values of the physics and/or non-physics parameters that were used to train the robot control model 152 at operation 702.

At operation 706, the model trainer 116 adjusts the ranges of values of one or more of the physics and/or non-physics parameters based on whether performance of the robot control model 152 determined at operation 704 is better or worse than a performance threshold. In at least one embodiment, the range of a parameter can be expanded if the robot control model 152 performs worse for values of the parameter that are slightly outside the range of values for the parameter, and vice versa, as described herein in conjunction with FIG. 5.

The process 700 then returns to operation 702, where the model trainer 116 further trains the robot control model 152 using reinforcement learning and simulations of the robot in which physics and/or non-physics parameters of the simulations are randomized within the adjusted ranges of values. In at least one embodiment, the operations 702-706 can be repeated for any number of iterations until a termination condition, such as acceptable performance of the robot control model, is reached.

FIG. 8 illustrates a flow diagram of a process 800 for controlling a robot using trained vision and robot control models, according to at least one embodiment. Although the process is described in conjunction with the systems of FIGS. 1-2, persons skilled in the art will understand that any system configured to perform the process in any order falls within the scope of the present embodiments.

As shown, the process 800 begins at operation 802, where the robot control application 146 receives captured images of a robot in a real-world environment. In at least one embodiment, the images can be captured by RGB cameras that are mounted on the robot and/or elsewhere in the environment. In at least one embodiment, the robot is interacting with one or more objects in the captured images. For example, the robot may be manipulating a cube and/or other object(s) in the captured images.

At operation 804, the robot control application 146 applies a trained vision model (e.g., vision model 150) to process the images of the robot. In at least one embodiment, the vision model can output a bounding shape, a segmentation, and keypoints associated with each of one or more objects that the robot interacts with in each image. In such cases, given (1) keypoints associated with object(s) the robot interacts with in multiple captured images that are output by the vision model after the multiple images are input into the vision model, and (2) known camera positions relative to each other, the robot control application 146 can perform triangulation to determine 3D positions of the keypoints, and then register the 3D positions of the keypoints against model(s) of the object(s) to obtain pose(s) of the object(s) the robot interacts with in a canonical reference frame.

At operation 806, the robot control application 146 applies a trained robot control model (e.g., robot control model 152) to generate an action for the robot to perform based on a goal, an output of the vision model (and/or a pose of the robot, such as when the robot is being controlled to move without interacting with object(s)), and previous states of the robot. In at least one embodiment, the action includes joint angles to be achieved by joints of the robot. In at least one embodiment, robot control application 146 can take as input the goal, the pose(s) of the object(s) described herein in conjunction with operation 804 (and/or a pose of the robot determined by, e.g., reading from an API that deals with the robot hardware), and the previous states of the robot.

At operation 808, the robot control application 146 causes the robot to move according to the action generated at operation 806. For example, in at least one embodiment, the robot control application 146 may transmit the action to a joint controller of the robot in order to cause the robot to move according to the action.

In sum, techniques are disclosed for using simulations to train machine learning models to control robots. In at least one embodiment, the machine learning models include a vision model that is trained to process images of a robot, which may interact with one or more objects, and a robot control model that is trained to generate robot actions based on a goal, an output of the vision model, and previous states of the robot. In at least one embodiment, the vision model is trained using (1) images of simulations of the robot that are rendered via ray tracing with different camera parameters and/or visual effects, and (2) augmentations of the rendered images. In at least one embodiment, the robot control model is trained using reinforcement learning and simulations of the robot in which physics and/or non-physics parameters of the simulations are randomized. In addition, an automatic domain randomization technique can be used to randomize the physics and/or non-physics parameters. Once trained, the vision model and the robot control model may be deployed to control a robot to perform tasks in a real-world environment.

At least one technical advantage of the disclosed techniques relative to the prior art is that, with the disclosed techniques, machine learning models may be trained using simulations and deployed to control robots to perform tasks in real-world environments. The trained machine learning models rely on images captured by RGB cameras, without requiring complicated marker-based setups. In addition, the disclosed techniques do not require real-world training that can cause damage to a robot or objects in an environment. These technical advantages represent one or more technological improvements over prior art approaches.

### Inference and Training Logic

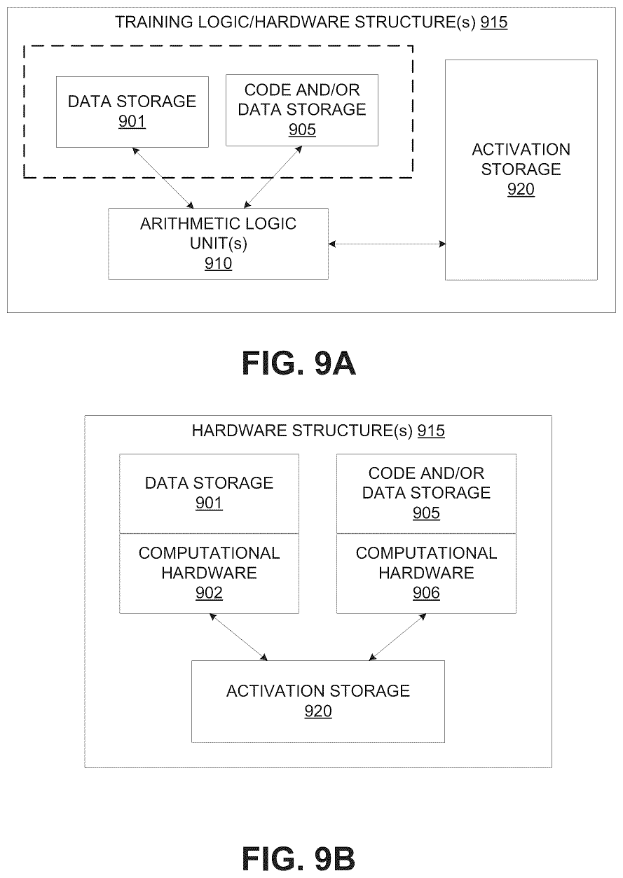

FIG. 9A illustrates inference and/or training logic 915 used to perform inferencing and/or training operations associated with one or more embodiments. Details regarding inference and/or training logic 915 are provided herein in conjunction with FIGS. 9A and/or 9B.

In at least one embodiment, inference and/or training logic 915 may include, without limitation, code and/or data storage 901 to store forward and/or output weight and/or input/output data, and/or other parameters to configure neurons or layers of a neural network trained and/or used for inferencing in aspects of one or more embodiments. In at least one embodiment, training logic 915 may include, or be coupled to code and/or data storage 901 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 901 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 901 may be included with other on-chip or off-chip data storage, including a processor's L1, L2, or L3 cache or system memory.

In at least one embodiment, any portion of code and/or data storage 901 may be internal or external to one or more processors or other hardware logic devices or circuits. In at least one embodiment, code and/or code and/or data storage 901 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 901 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 may include, without limitation, a code and/or data storage 905 to store backward and/or output weight and/or input/output data corresponding to neurons or layers of a neural network trained and/or used for inferencing in aspects of one or more embodiments. In at least one embodiment, code and/or data storage 905 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 915 may include, or be coupled to code and/or data storage 905 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 905 may be included with other on-chip or off-chip data storage, including a processor's L1, L2, or L3 cache or system memory. In at least one embodiment, any portion of code and/or data storage 905 may be internal or external to one or more processors or other hardware logic devices or circuits. In at least one embodiment, code and/or data storage 905 may be cache memory, DRAM, SRAM, non-volatile memory (e.g., flash memory), or other storage. In at least one embodiment, a choice of whether code and/or data storage 905 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 901 and code and/or data storage 905 may be separate storage structures. In at least one embodiment, code and/or data storage 901 and code and/or data storage 905 may be a combined storage structure. In at least one embodiment, code and/or data storage 901 and code and/or data storage 905 may be partially combined and partially separate. In at least one embodiment, any portion of code and/or data storage 901 and code and/or data storage 905 may be included with other on-chip or off-chip data storage, including a processor's L1, L2, or L3 cache or system memory.

In at least one embodiment, inference and/or training logic 915 may include, without limitation, one or more arithmetic logic unit(s) (“ALU(s)”) 910, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 920 that are functions of input/output and/or weight parameter data stored in code and/or data storage 901 and/or code and/or data storage 905. In at least one embodiment, activations stored in activation storage 920 are generated according to linear algebraic and or matrix-based mathematics performed by ALU(s) 910 in response to performing instructions or other code, wherein weight values stored in code and/or data storage 905 and/or data storage 901 are used as operands along with other values, such as bias values, gradient information, momentum values, or other parameters or hyperparameters, any or all of which may be stored in code and/or data storage 905 or code and/or data storage 901 or another storage on or off-chip.

In at least one embodiment, ALU(s) 910 are included within one or more processors or other hardware logic devices or circuits, whereas in another embodiment, ALU(s) 910 may be external to a processor or other hardware logic device or circuit that uses them (e.g., a co-processor). In at least one embodiment, ALUs 910 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 901, code and/or data storage 905, and activation storage 920 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 920 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 920 may be cache memory, DRAM, SRAM, non-volatile memory (e.g., flash memory), or other storage. In at least one embodiment, activation storage 920 may be completely or partially within or external to one or more processors or other logical circuits. In at least one embodiment, a choice of whether activation storage 920 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 illustrated in FIG. 9A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9A may be used in conjunction with central processing unit (“CPU”) hardware, graphics processing unit (“GPU”) hardware or other hardware, such as field programmable gate arrays (“FPGAs”).

FIG. 9B illustrates inference and/or training logic 915, according to at least one embodiment. In at least one embodiment, inference and/or training logic 915 may include, without limitation, hardware logic in which computational resources are dedicated or otherwise exclusively used in conjunction with weight values or other information corresponding to one or more layers of neurons within a neural network. In at least one embodiment, inference and/or training logic 915 illustrated in FIG. 9B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9B may be used in conjunction with central processing unit (CPU) hardware, graphics processing unit (GPU) hardware or other hardware, such as field programmable gate arrays (FPGAs). In at least one embodiment, inference and/or training logic 915 includes, without limitation, code and/or data storage 901 and code and/or data storage 905, which may be used to store code (e.g., graph code), weight values and/or other information, including bias values, gradient information, momentum values, and/or other parameter or hyperparameter information. In at least one embodiment illustrated in FIG. 9B, each of code and/or data storage 901 and code and/or data storage 905 is associated with a dedicated computational resource, such as computational hardware 902 and computational hardware 906, respectively. In at least one embodiment, each of computational hardware 902 and computational hardware 906 comprises one or more ALUs that perform mathematical functions, such as linear algebraic functions, only on information stored in code and/or data storage 901 and code and/or data storage 905, respectively, result of which is stored in activation storage 920.

In at least one embodiment, each of code and/or data storage 901 and 905 and corresponding computational hardware 902 and 906, respectively, correspond to different layers of a neural network, such that resulting activation from one storage/computational pair 901/902 of code and/or data storage 901 and computational hardware 902 is provided as an input to a next storage/computational pair 905/906 of code and/or data storage 905 and computational hardware 906, in order to mirror a conceptual organization of a neural network. In at least one embodiment, each of storage/computational pairs 901/902 and 905/906 may correspond to more than one neural network layer. In at least one embodiment, additional storage/computation pairs (not shown) subsequent to or in parallel with storage/computation pairs 901/902 and 905/906 may be included in inference and/or training logic 915.

### Neural Network Training and Deployment

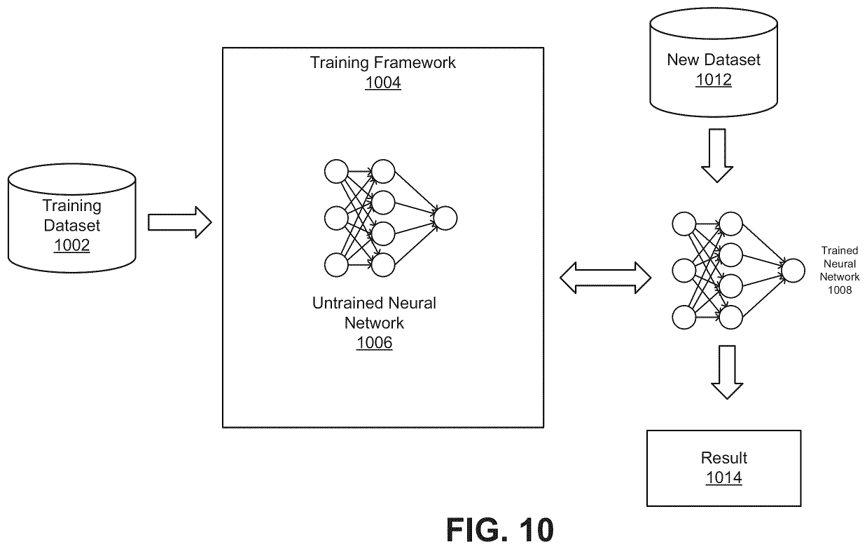

FIG. 10 illustrates training and deployment of a deep neural network, according to at least one embodiment. In at least one embodiment, untrained neural network 1006 is trained using a training dataset 1002. In at least one embodiment, training framework 1004 is a PyTorch framework, whereas in other embodiments, training framework 1004 is a TensorFlow, Boost, Caffe, Microsoft Cognitive Toolkit/CNTK, MXNet, Chainer, Keras, Deeplearning4j, or other training framework. In at least one embodiment, training framework 1004 trains an untrained neural network 1006 and enables it to be trained using processing resources described herein to generate a trained neural network 1008. In at least one embodiment, weights may be chosen randomly or by pre-training using a deep belief network. In at least one embodiment, training may be performed in either a supervised, partially supervised, or unsupervised manner.

In at least one embodiment, untrained neural network 1006 is trained using supervised learning, wherein training dataset 1002 includes an input paired with a desired output for an input, or where training dataset 1002 includes input having a known output and an output of neural network 1006 is manually graded. In at least one embodiment, untrained neural network 1006 is trained in a supervised manner and processes inputs from training dataset 1002 and compares resulting outputs against a set of expected or desired outputs. In at least one embodiment, errors are then propagated back through untrained neural network 1006. In at least one embodiment, training framework 1004 adjusts weights that control untrained neural network 1006. In at least one embodiment, training framework 1004 includes tools to monitor how well untrained neural network 1006 is converging towards a model, such as trained neural network 1008, suitable to generating correct answers, such as in result 1014, based on input data such as a new dataset 1012. In at least one embodiment, training framework 1004 trains untrained neural network 1006 repeatedly while adjust weights to refine an output of untrained neural network 1006 using a loss function and adjustment algorithm, such as stochastic gradient descent. In at least one embodiment, training framework 1004 trains untrained neural network 1006 until untrained neural network 1006 achieves a desired accuracy. In at least one embodiment, trained neural network 1008 can then be deployed to implement any number of machine learning operations.

In at least one embodiment, untrained neural network 1006 is trained using unsupervised learning, wherein untrained neural network 1006 attempts to train itself using unlabeled data. In at least one embodiment, unsupervised learning training dataset 1002 will include input data without any associated output data or “ground truth” data. In at least one embodiment, untrained neural network 1006 can learn groupings within training dataset 1002 and can determine how individual inputs are related to untrained dataset 1002. In at least one embodiment, unsupervised training can be used to generate a self-organizing map in trained neural network 1008 capable of performing operations useful in reducing dimensionality of new dataset 1012. In at least one embodiment, unsupervised training can also be used to perform anomaly detection, which allows identification of data points in new dataset 1012 that deviate from normal patterns of new dataset 1012.

In at least one embodiment, semi-supervised learning may be used, which is a technique in which in training dataset 1002 includes a mix of labeled and unlabeled data. In at least one embodiment, training framework 1004 may be used to perform incremental learning, such as through transferred learning techniques. In at least one embodiment, incremental learning enables trained neural network 1008 to adapt to new dataset 1012 without forgetting knowledge instilled within trained neural network 1008 during initial training.

In at least one embodiment, training framework 1004 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based nueral networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
rendering one or more images based at least on one or more first simulations of a robot;
performing one or more first operations to train a first machine learning model to process images of the robot based at least on the one or more images;
performing one or more second operations to train a second machine learning model to control the robot based at least on one or more second simulations of the robot; and
performing one or more control operations corresponding to the robot based at least on one or more outputs of the first machine learning model and the second machine learning model.

2. The method of claim 1, wherein the one or more images are rendered based at least on at least one of different camera parameters, different visual effects, or performing one or more ray tracing operations.

3. The method of claim 1, further comprising:
performing one or more third operations to augment the one or more images based at least on at least one of a lighting augmentation, a texture augmentation, or a geometry augmentation to generate one or more augmented images; and
performing one or more fourth operations to train the first machine learning model based at least on the one or more augmented images.

4. The method of claim 1, wherein the one or more second operations to train the second machine learning model comprise one or more reinforcement learning operations.

5. The method of claim 1, wherein the one or more second simulations of the robot includes a plurality of simulations of the robot based at least on at least one of different physics parameters or different non-physics parameters.

6. The method of claim 5, wherein the plurality of simulations are performed in parallel using one or more graphics processing units (GPUs).

7. The method of claim 5, further comprising performing one or more automatic domain randomization operations to determine ranges of the at least one of different physics parameters or different non-physics parameters.

8. The method of claim 1, wherein the first machine learning model comprises a mask region-based convolutional neural network (Mask-RCNN) architecture.

9. The method of claim 1, wherein the second machine learning model comprises a long short-term memory (LS™) neural network architecture.

10. The method of claim 1, further comprising performing one or more third operations to train a third machine learning model that evaluates at least one output of the second machine learning model, wherein the third machine learning model has access to more information associated with the one or more second simulations than the second machine learning model.

11. A method comprising:
determining a pose based at least on processing a plurality of images of a robot using a first machine learning model, the first machine learning model being trained based at least on one or more rendered images corresponding to one or more first simulations of the robot;
generating an action based at least on processing the pose, a goal, and one or more previous states of the robot using a second machine learning model, the second machine learning model being trained based at least on one or more second simulations of the robot; and
controlling the robot based at least on the action.

12. The method of claim 11, wherein the first machine learning model generates, for at least one image included in the plurality of images, a bounding shape, a segmentation, and one or more keypoints associated with at least one of the robot or an object that the robot interacts with in the at least one image, and the determining the pose comprises:
determining one or more three-dimensional (3D) positions based at least on the one or more keypoints associated with the at least one of the robot or the object; and
determining the pose based at least on a registration of the one or more 3D positions against one or more models of the at least one of the robot or the object.

13. The method of claim 11, wherein the one or more rendered images are rendered based at least on at least one of different camera parameters, different visual effects, or performing one or more ray tracing operations.

14. The method of claim 11, wherein the first machine learning model is further trained based at least on one or more augmented images, and the one or more augmented images are generated by performing one or more operations to augment the one or more rendered images based at least on at least one of a lighting augmentation, a texture augmentation, or a geometry augmentation.

15. The method of claim 11, wherein the second machine learning model is trained by performing one or more operations to simulate the robot in a plurality of simulations, and the plurality of simulations are based at least on at least one of different physics parameters or different non-physics parameters.

16. The method of claim 15, wherein the plurality of simulations are performed in parallel using one or more graphics processing units (GPUs).

17. The method of claim 15, wherein the second machine learning model is trained by further performing one or more automatic domain randomization operations to determine ranges of the at least one of different physics parameters or different non-physics parameters.

18. A system comprising:
one or more processors to:
control a robot using one or more machine learning models trained based at least on one or more simulations of the robot and one or more images rendered based at least on the one or more simulations.

19. The system of claim 18, wherein the one or more images are associated with at least one of different camera parameters, different visual effects, or different augmentations.

20. The system of claim 18, wherein the one or more simulations include a plurality of simulations that are based at least on at least one of different physics parameters or different non-physics parameters.
